(19) United States
(12) Patent Application Publication
(10) Pub. No.: US 2016/0269276 A1
(43) Pub. Date: Sep. 15, 2016

(54) METHOD FOR AVOIDING A LOOP WHEN FORWARDING A MESSAGE, RESPECTIVE COMMUNICATIONS DEVICE AND SYSTEM

(71) Applicant: TOMSON LICENSING, Issy-les-Moulineaux (FR)

(72) Inventors: Luc GYSELINCK, Zoersel (BE); Jan VOET, Schilde (BE); Bram STES, Antwerpen (BE)

(21) Appl. No.: 15/031,708

(22) PCT Filed: Oct. 17, 2014
(86) PCT No.: PCT/EP2014/072300

§ 371 Date: Apr. 22, 2016

(30) Foreign Application Priority Data
Oct. 24, 2013 (EP) 13290256.0

(51) Int. Cl. H04L 12/705; H04L 29/06; H04L 12/28

(52) U.S. Cl. CPC H04L 45/18; H04L 12/2801; H04L 12/2854; H04L 65/608; H04L 65/102

(57) ABSTRACT

The method for avoiding a loop when forwarding a message from a first participant of a first LAN to a participant of a second LAN via several forwarding servers of a wide area network (WAN) comprises the steps of: including each time an identifying address of the sending forwarding server in the message by the receiving forwarding server, and keeping each identifying address in the message. The message is in particular an RTPS message including an InfoSource submessage, and each added identifying address is stored in the InfoSource submessage.

### TECHNICAL FIELD

The invention relates to the field of communications devices, in particular to Internet servers and residential gateways being arranged within a home network and adapted to operate via a broadband connection with a service provider network.

### BACKGROUND OF THE INVENTION

Residential gateways are widely used to connect devices in a home of a customer to the Internet or to any other wide area network (WAN). Residential gateways use for example digital subscriber line (DSL) technology that enables a high data rate transmission over copper lines, or use optical fiber broadband transmission systems, e.g. fiber-to-the-home (FTTH) or fiber-to-the premises (FTTP).

Home networks have become part of everyday life for many customers. A home network consists of a range of heterogeneous devices, which means that the home network is made up of different kinds of devices. All these devices need to communicate with each other. For this interconnection, multiple solutions are available. The home network uses a mixture of solutions, such as wireless and wired network connections. Combining these devices creates a network that allows users to share information and control devices in the home. Examples of networked devices in the home are for example residential gateways, set-top boxes, TVs, personal computers, tablet PCs, smart phones, network-attached storage (NAS) devices, printers and game consoles.

DDS (Data Distribution Service for Real-Time Systems) is a standard governed by the Object Management Group (OMG). It describes a data-centric publish-subscribe middleware that can be used to build distributed real-time systems. Since its formal adoption as an OMG standard in the year 2004, it has become a popular technology being used in many different industries such as the airline/aviation industry, the automotive industry, the military, etc. Several commercial and open-source implementations of the DDS standard exist.

To allow different DDS implementations to interoperate, they must implement a second OMG standard, called the Real-Time Publish-Subscribe Wire Protocol—DDS Interoperability Wire Protocol Specification (RTPS, also abbreviated DDSI). RTPS specifies how DDS entities (Domains, Participants, Publishers, Subscribers, Readers, Writers, Topics, . . . ) are mapped to RIPS entities (domains, participants, endpoints and optionally topics), the format of the messages that are exchanged between the participants/endpoints, and also valid message sequences of message exchanges between participants/endpoints, as well as a mechanism for discovering other participants and endpoints within a RTPS domain. The latest version of DDS is currently the version v1.2 and the latest version of the Real-Time Publish-Subscribe Wire Protocol is the version v2.1, which are both published by the OMG on its Internet site under www.OMG.org.

A new network communication paradigm is designed building upon DDS, which uses a DDS forwarding functionality to interconnect DDS peers residing in a LAN (Local Area Network) with DDS peers residing outside the LAN, e.g. in another LAN or the WAN, e.g. Internet. In a large network topology, it is possible to have multiple forwarders, e.g. forwarding servers of the Internet, involved in a communication between two DDS peers.

The RTPS message is described in detail in the RTPS wire protocol specification: An RTPS domain contains a set of participants, each comprising local endpoints: readers and writers. The writers of participants communicate with readers within the domain by sending RTPS messages. All RTPS messages comprise a header followed by a variable number of submessages. Each submessage contains a submessage header and a submessage element. The RTPS protocol version 2.1 defines several kinds of submessages, which are categorized into two groups: entity submessages and interpreter submessages. Entity submessages are for example data, DATA_FRAG and HEARTBEAT messages and target an RTPS Entity. The interpreter submessages are: INFO_SOURCE, INFO_DESTINATION, INFO_REPLY, INFO_TIMESTAMP and PAD. Interpreter Submessages modify the RTPS Receiver state and provide context that helps to process subsequent Entity Submessages. The INFO_SOURCE and INFO_DESTINATION submessages are primarily used for relaying RTPS submessages.

Each RTPS entity includes a globally unique identifier (GUID), which uniquely identifies the entity within a DDS domain. The GUID includes a prefix: GUID prefix, which uniquely identifies a participant within the DDS domain, and an entity identifier: entityID, which uniquely identifies the entity within the participant. The header of an RTPS message identifies the RTPS message as belonging to the RTPS protocol and includes a field that indicates the vendor providing the implementation of the RTPS protocol and a field: GUIDprefix, which is used to reconstruct the GUID that appears within the submessages contained in the RTPS message, and includes the name of the participant sending the RTPS message.

FIG. 1 gives an example of a network setup with three forwarders F1, F2, F3 forwarding a DDS message M between two DDS peers, being represented by participants A and B. In this example, when participant A publishes the DDS message M, the message will be handled by the intermediate forwarders: F1 will forward to F2, F2 will forward to F3, and F3 will forward to both participant B and F1. When the message M arrives again at F1, a loop has occurred: the same message from A and from F3 arrived at F1. Based on the RIPS protocol, F1 cannot detect that a loop has occurred and forwards the DDS message again to F2. The current RIPS protocol, the wire protocol used by the participants A, B, has no means to detect loops within a network.

This loop as shown in FIG. 1 must be detected and prevented.

The DDS message as described with regard to FIG. 1 is in particular an RIPS message. The RIPS message sent by participant A in FIG. 1 is depicted in FIG. 2 in a simplified manner: The RIPS message includes in the RIPS message header the field Guidprefix=A, identifying the participant A sending the RIPS message, and data. The forwarder F1, receiving and forwarding the RIPS message to the forwarder F2, includes an INFO_SOURCE submessage with a field: GUIDprefix=A, which submessage is primarily used for relaying RIPS submessages. The forwarders F1, F2 and F3 include further their name in the GUIDprefix of the RIPS message header, when forwarding the RIPS message. When the forwarder F3 forwards the RIPS message to forwarder F1, the forwarder F1 cannot recognize that it has received already this RIPS message and forwards the RIPS message again.

It is noted that in FIG. 2 no details are given to represent a full RIPS message with all submessages. Focus is made on the message containing information in the InfoSource submessage.

U.S. Pat. No. 7,558,210 discloses a system for detecting and correcting publish-subscribe looping in a messaging network, which requires a token, which uniquely identifies a node in this network, or which is universally unique in this network. The system maintains a list of Universally Unique Identifiers (UUID) as a metadata attached to each publish-subscribe message. As a node forwards a message to another node, it is required to append its own UUID to this list, or discard the message, if its UUID already is in the attached list.

### SUMMARY OF THE INVENTION

The method for avoiding a loop when forwarding a message from a first participant of a first LAN to a participant of a second LAN via several forwarding servers of a wide area network (WAN) comprises the steps of: including each time an identifying address of the sending forwarding server in the message by the receiving forwarding server, and keeping each identifying address in the message. The forwarding servers are in particular Internet servers forwarding messages in accordance with a Data Distribution Service for Real-Time Systems (DDS) or in accordance with a Real-Time Publish-Subscribe Wire Protocol—DDS Interoperability Wire Protocol (RTPS). The identifying address is advantageously a GUIDPrefix of an RTPS message. The message is in particular a DDS message or a RTPS message.

In an aspect of the invention, the message includes a submessage, and each added identifying address is stored in the submessage.

In another aspect of the invention, the message is an RIPS message including an InfoSource submessage, and each added identifying address is stored in the InfoSource submessage. Advantageously, the entity from which the message was received is added in the InfoSource submessage: a first forwarder adds the GUIDPrefix of the sending participant, a second forwarder adds the GUIDPrefix of the first forwarder, and a third forwarder: the GUIDPrefix of the second forwarder. To detect a loop, the first forwarder inspects the InfoSource submessage, and when the InfoSource submessage already contains the GUIDPrefix of the first forwarder, then the first forwarder drops this message to prevent a loop.

A communications device utilizing the method is for example a customer premises equipment (CPE) device comprising a microprocessor, a non-volatile memory, in which an operating system is stored, and a volatile memory for the operation of the CPE device.

A system utilizing the method comprises a first participant of a first Local Area Network (LAN), a participant of a second LAN and several forwarding servers of a wide area network (WAN),

The main idea is thus to extend the RIPS InfoSource submessage. According to the standard RIPS, the InfoSource submessage provides information about the source from which subsequent Entity submessages originated. This submessage is primarily used for relaying RIPS submessages.

The important thing to notice is that only one source is contained within the standard InfoSource submessage. To address the loop detection mechanism when forwarding (relaying) RIPS messages, additional entities, identifying the intermediate forwarders, are added to the InfoSource submessage.

### BRIEF DESCRIPTION OF THE DRAWINGS

Preferred embodiments of the invention are explained in more detail below by way of example with reference to schematic drawings, which show:

FIG. 1 a network setup including three forwarders forwarding a DDS message between two DDS peers,

FIG. 2 the network setup of FIG. 1, forwarding an RIPS message including a standard InfoSource submessage, and

FIG. 3 the network setup of FIG. 1, forwarding an RIPS message including an extended InfoSource submessage according to the invention.

### DETAILED DESCRIPTION OF PREFERRED EMBODIMENTS

In the following description, a method for avoiding a loop, a respective system and a respective communications device are described. The communications device is for example a customer premises equipment (CPE) device, e.g. an access gateway, adapted for connecting a home network with a service provider network via a broadband connection. For purposes of explanation, numerous specific details are set forth in order to provide a thorough understanding of the embodiments. It will be evident, however, to one skilled in the art that the present invention may be practiced without these specific details.

The CPE device includes for example a controller, e.g. a microprocessor, a non-volatile memory, in which an operating system is stored, a volatile memory for the operation of the CPE device, a wireless node for a wireless operation, and a broadband connection, e.g. an xDSL connection. The wireless node includes a complex software driver, a physical layer with data buffers, and an antenna. A CPE device of this kind is for example a residential gateway, which has a central position within a wireless local area network (WLAN).

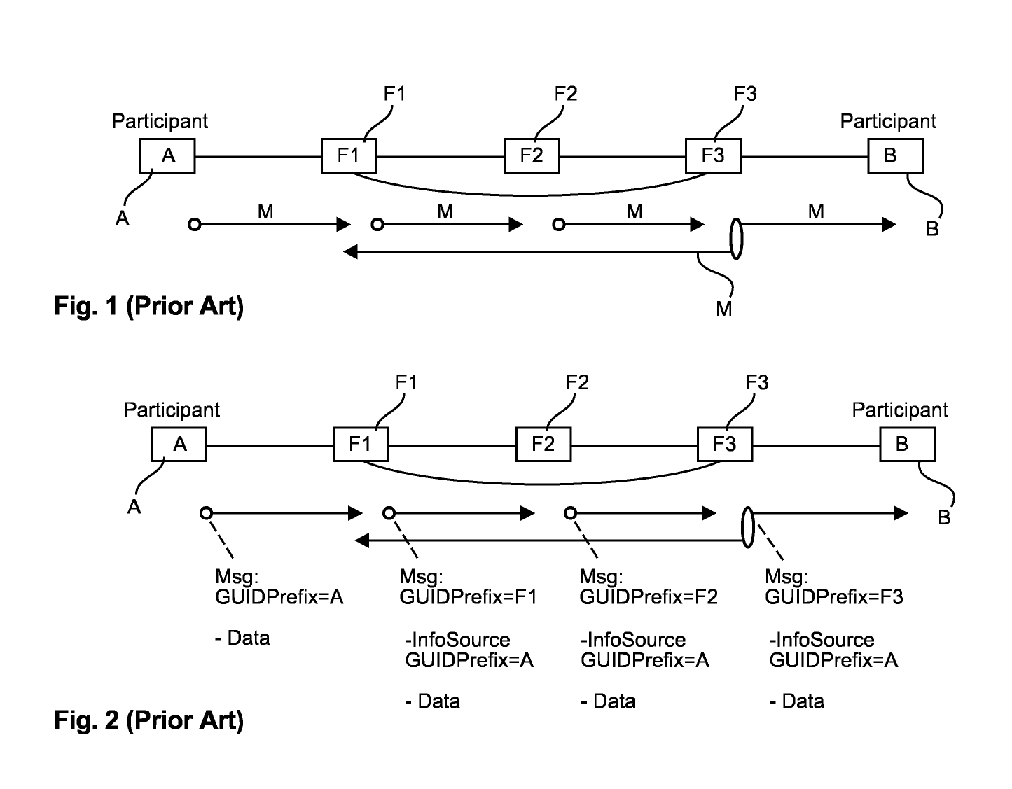

The system includes DDS peers residing in a LAN (Local Area Network) with DDS peers residing outside the LAN. The system includes for example participants A and B and forwarders F1-F3, as depicted in FIGS. 1 and 2. The participants A, B communicate with each other via the forwarders according to a Real-time Publish-Subscribe Wire Protocol DDS Interoperability Wire Protocol Specification (DDS-RTPS), by using publish/subscribe messages, called RTPS messages. Each RTPS message contains a variable number of RTPS submessages. Each RTPS submessage in turn is built from a set of predefined atomic building blocks called SubmessageElements. The RTPS protocol version 2.1 defines several kinds of submessages, as described before.

Loop detection is possible by making intermediates, i.e. the RTPS forwarders/relayers F1-F3, e.g. provided by Internet servers, to add in the InfoSource submessage the entity from which the message was received, advantageously the GUIDPrefix mentioned in the RTPS message received.

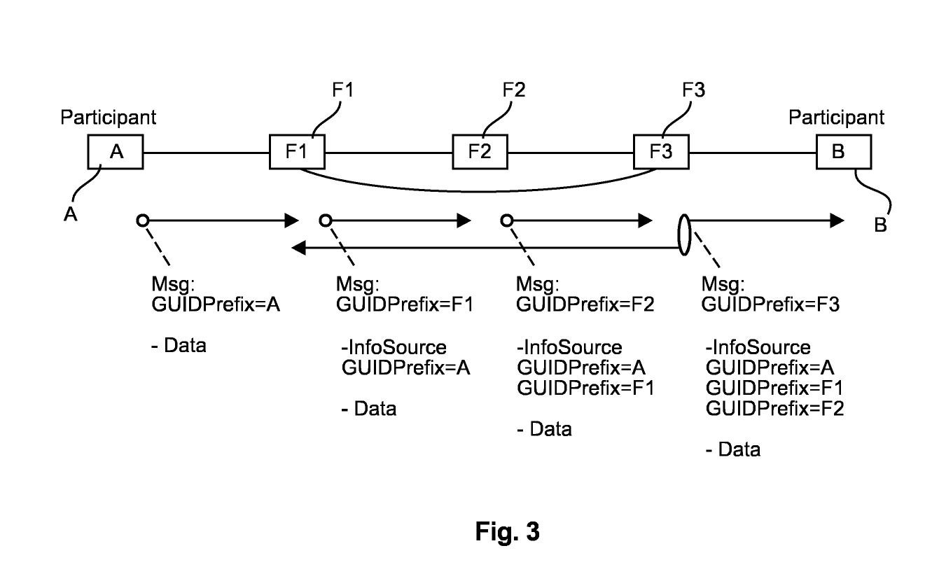

As can be seen in FIG. 3:
forwarder F1 adds GUIDPrefix=A in the InfoSource, the first entity in the InfoSource, identifying participant A, from which the message was received.
forwarder F2 adds GUIDPrefix=F1 in the InfoSource, the second entity in the InfoSource, identifying forwarder F1, from which the forwarder F2 received the message.
forwarder F3 adds GUIDPrefix=F2 in the InfoSource, the third entity in the InfoSource, identifying forwarder F2.
when F3 forwards the message on its output interfaces towards Participant B and Forwarder F1, F1 can easily detect the loop by inspecting the InfoSource submessage, which contains already the GUIDPrefix=F1. As such, forwarder F1 will drop this RIPS message, preventing the loop to continue.

Advantages of the invention: The presented mechanism allows RIPS forwarders to detect and prevent loops in a network topology.

Also other embodiments of the invention may be utilized by one skilled in the art without departing from the scope of the present invention. The invention resides therefore in the claims herein after appended.

1. Method for avoiding a loop when forwarding a message from a first participant of a first Local Area Network to a participant of a second LAN via several forwarding servers of a wide area network, comprising the steps of
including each time an identifying address of the sending forwarding server in the message by the receiving forwarding server, and keeping each identifying address in the message.

2. Method according to claim 1, wherein the forwarding servers are Internet servers forwarding messages in accordance with a Data Distribution Service for Real-Time Systems (DDS) or in accordance with a Real-Time Publish-Subscribe Wire Protocol—DDS Interoperability Wire Protocol (RTPS).

3. Method according to claim 1, wherein the message is a DDS message.

4. Method according to claim 1, wherein the message is a RTPS message.

5. Method according to claim 4, wherein the identifying address is a GUIDPrefix of the RTPS message.

6. Method according to claim 1, wherein the message includes a submessage.

7. Method according to claim 6, wherein the message includes an InfoSource submessage.

8. Method according to claim 6, wherein each added identifying address is stored in the submessage.

9. Method according to claim 7, wherein each added identifying address is stored in the InfoSource submessage.

10. Method according to claim 9, comprising the step of adding in the InfoSource submessage the entity from which the message was received: first forwarder: the GUIDPrefix of the sending participant, second forwarder: the GUIDPrefix of the first forwarder, and a third forwarder: the GUIDPrefix of second forwarder.

11. Method according to claim 9, comprising the step of the first forwarder inspecting the InfoSource submessage to detect a loop, and when the InfoSource submessage already contains the GUIDPrefix of the first forwarder, then the first forwarder drops this message to prevent a loop.

12. Communications device utilizing a method according to claim 1.

13. Communications device according to claim 12, wherein the communications device is a customer premises equipment (CPE) device comprising a microprocessor, a non-volatile memory, in which an operating system is stored, and a volatile memory for the operation of the CPE device.

14. System comprising a first participant (A) of a first Local Area Network (LAN), a participant (B) of a second LAN and several forwarding servers (F1-F3) of a wide area network (WAN), the system utilizing a method according to claim 1.
